(19) United States
(12) Patent Application Publication
(10) Pub. No.: US 2017/0291535 A1
(43) Pub. Date: Oct. 12, 2017

(54) SAFETY TURN PANEL

(71) Applicant: Claude Arcand, Longueuil (CA)

(72) Inventor: Claude Arcand, Longueuil (CA)

(21) Appl. No.: 15/480,487

(22) Filed: Apr. 6, 2017

(30) Foreign Application Priority Data
Apr. 9, 2016 (GB) 1606047.7

(51) Int. Cl. B60Q 1/36; B60Q 1/50; B60Q 1/34

(52) U.S. Cl. CPC B60Q 1/36; B60Q 1/346; B60Q 1/503

(57) ABSTRACT

A safety turn panel system comprising a base member configured to be attached to a tractor unit of a semi-trailer truck; an arm member rotationally attached to the base member; a sign attached to the arm member, wherein the sign includes flashing lights in a warning text configuration and at least one reflecting panel; and a remote control unit configured to control the sign from a deactivated to an activated position.

### CROSS-REFERENCE TO RELATED APPLICATIONS

The present application claims priority to Great Britain Patent Application serial number GB1606047.7, filed on Apr. 9, 2016 entitled “Safety turn panel”, the disclosure of which is hereby incorporated in its entirety at least by reference.

### BACKGROUND OF THE INVENTION

### 1. Field of the Invention

The present invention generally relates to holding devices but more particularly to a safety turn panel for use on semi-trailer truck.

### 2. Description of Related Art

When a tractor unit of a semi-trailer truck, also known as a semi-truck, semi, transport truck, tractor-trailer, or eighteen-wheeler, is required to make a sharp turn relative to the trailer unit a dead angle or blind spot is present. This typically occurs when turning at an intersection when the semi-truck may use two or more traffic lanes, or backing up to a loading bay or dock platform as turning maneuvers while simultaneously backing is necessary. In many circumstances, the driver needs to enlist the help of someone to get guidance and to make sure that no one gets in the way, causing injury and even death. Assistance is not always possible, in which case the driver has to proceed with caution, monitoring all his mirrors and looking around. This slows down the docking process and is not entirely safe since the driver's view is restricted, leading to the possibility of an accident. Consequently, a solution providing a safe and efficient way of backing up and docking is needed.

### BRIEF SUMMARY OF THE INVENTION

In one embodiment of the present invention, a safety turn panel system is provided comprising a base member configured to be attached to a tractor unit of a semi-trailer truck; an arm member rotationally attached to the base member; a sign attached to the arm member, wherein the sign includes flashing lights in a warning text configuration and at least one reflecting panel; and a remote control unit configured to control the sign from a deactivated to an activated position.

In one embodiment, the arm member includes a pair of arm sections. In one embodiment, the sign is a swing out sign constructed of an octagon shape. In another embodiment, the swing out sign is provided to warn people in a surrounding area that the semi-trailer truck is backing up and a plurality of blind spots are present.

In another aspect of the invention, a safety turn panel is provided comprising a base member configured to be attached to a tractor unit of a semi-trailer truck; an arm member rotationally attached to the base member; a swing out sign attached to the arm member, wherein the swing out sign includes flashing lights in a warning text configuration and at least one reflecting panel; and an actuation means for controlling the swing out sign from a closed to an open position.

In one embodiment, the arm member includes a pair of arm sections. In one embodiment, the sign is a swing out sign constructed of an octagon shape. In another embodiment, the swing out sign is provided to warn people in a surrounding area that the semi-trailer truck is backing up and a plurality of blind spots are present. In yet another embodiment, the actuation means is a remote control unit. In one embodiment, the actuation means is an existing flasher switch in the semi-trailer truck. In another embodiment, the actuation means is a sensor on an axle of the semi-trailer truck configured to detect that the semi-trailer truck is backing up.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a perspective view of a safety turn panel for use on a semi-trailer truck according to an embodiment of the present invention.

FIG. 2 is a perspective view of a safety turn panel in an activated position and a remote control unit according to an embodiment of the present invention.

FIG. 3 is a perspective view of a safety turn panel in a deactivated position and a remote control unit according to an embodiment of the present invention.

FIG. 4 is a perspective view of a safety turn panel for use on a semi-trailer truck in a deactivated position according to an embodiment of the present invention.

FIG. 5 is a rear perspective view of a safety turn panel in a deactivated position and a remote control unit according to an embodiment of the present invention.

FIGS. 6A-F are various perspective views of a safety turn panel and a remote control unit according to an embodiment of the present invention.

### DETAILED DESCRIPTION OF THE PREFERRED EMBODIMENT

The following description is provided to enable any person skilled in the art to make and use the invention and sets forth the best modes contemplated by the inventor of carrying out their invention. Various modifications, however, will remain readily apparent to those skilled in the art, since the general principles of the present invention have been defined herein to specifically provide a safety turn panel for use on a semi-trailer truck.

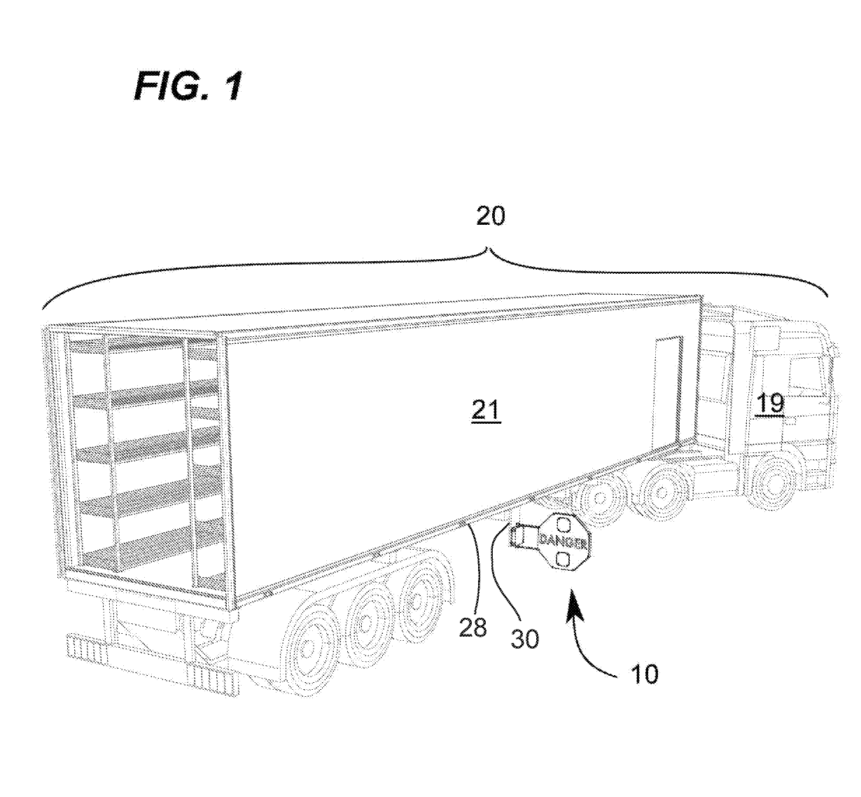

FIG. 1 is a perspective view of a safety turn panel 10 for use on a semi-trailer truck 20 according to an embodiment of the present invention. Referring now to FIG. 1, a semi-trailer truck comprises a tractor unit 19 and a trailer unit 21. The safety turn panel is attached to the trailer unit as illustrated. In one embodiment, the safety turn panel is attached to either side of the trailer unit. In a preferred embodiment, two safety turn panels are attached to both sides of the trailer unit.

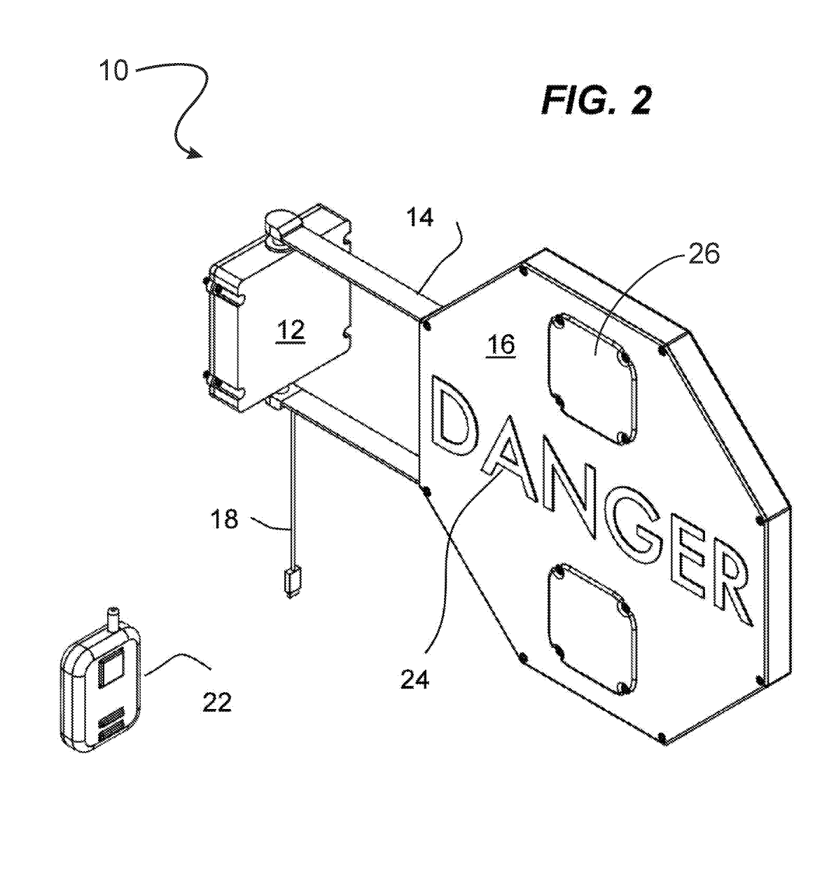

FIG. 2 is a perspective view of a safety turn panel 10 in an activated position and a remote control unit 22 according to an embodiment of the present invention. Referring now to FIG. 2, the safety turn panel comprises a base member 12, arm member 14, and sign 16. The sign is a swing out sign configured to appear similar to existing stop signs to be easily recognizable. In one embodiment, the sign is an octagon. In another embodiment, the sign is red. In yet another embodiment, the sign includes flashing lights 24 and at least one reflecting panel 26. It is a particular advantage of the present invention that the flashing lights comprise text heeding a warning, such as “danger” to people in the area, while the flashing lights increase visibility, during both the day and night time. At least one reflecting panel is provided, but several reflecting panels may be included. It should be understood, the text, shape, and color of the sign may be modified without departing from the scope of the invention. The swing out sign is intended to warn people in the surrounding area that the semi-trailer truck is backing up and that blind spots are present.

The base is attached to the trailer unit, by suitable means well known in the art. As previously mentioned, in a preferred embodiment, two safety turn panels are attached to both sides of the trailer unit via the base of each of the safety turn panels. In one embodiment, the base may be attached at a location corresponding to a driver's blind spot. In another embodiment, the based may be attached at convenient locations, including but not limited to a support leg (not illustrated), lower side rail 28, or panel 30 (As seen in FIG. 1).

The arm member 14 includes a pair of arm sections rotationally attached to the base member on one end and the sign at the other end. The arm member is of a sufficient length to enable the swinging of the sign to be clearly visible to surrounding people, without causing possible damage to surrounding elements or being an obstruction to the driver by extending too far from the trailer unit.

Still referring to FIG. 2, a power cable 18 is provided to supply electrical power may be connected to an existing power source as well known in the art. In one embodiment, a remote control unit 22 is provided to control the operation of the safety turn panel from a deactivated to an activated position. This will be discussed in greater details below.

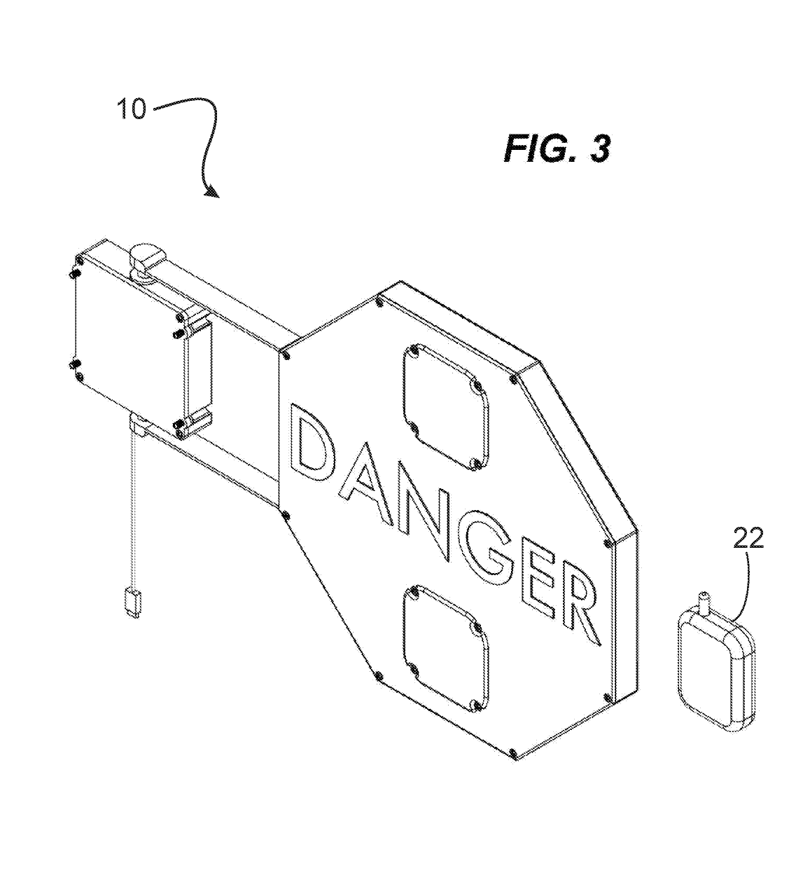

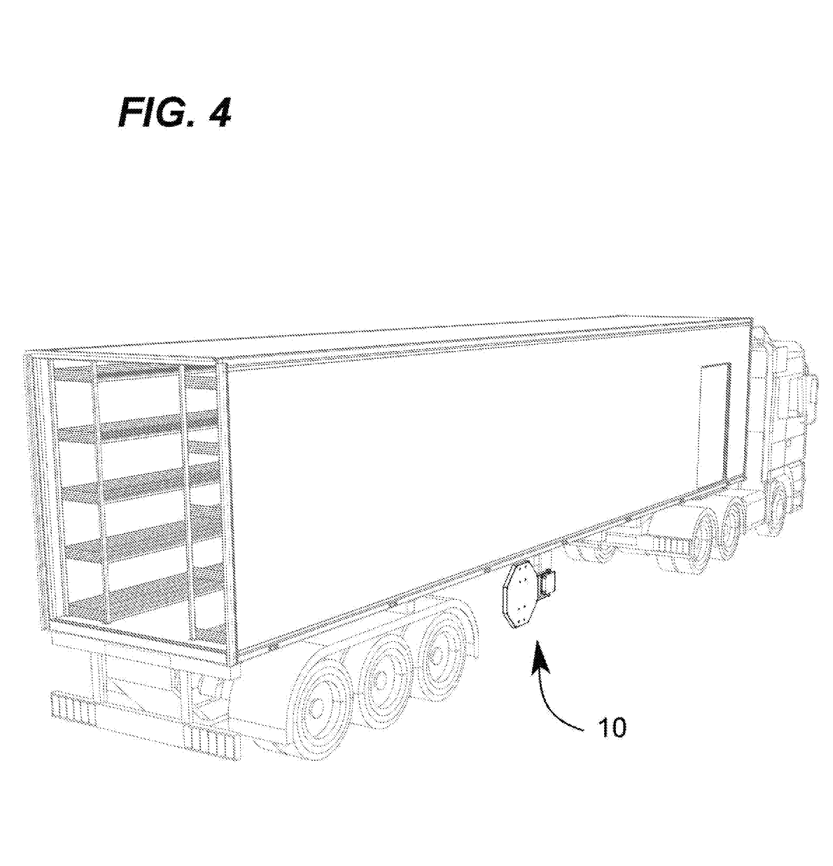

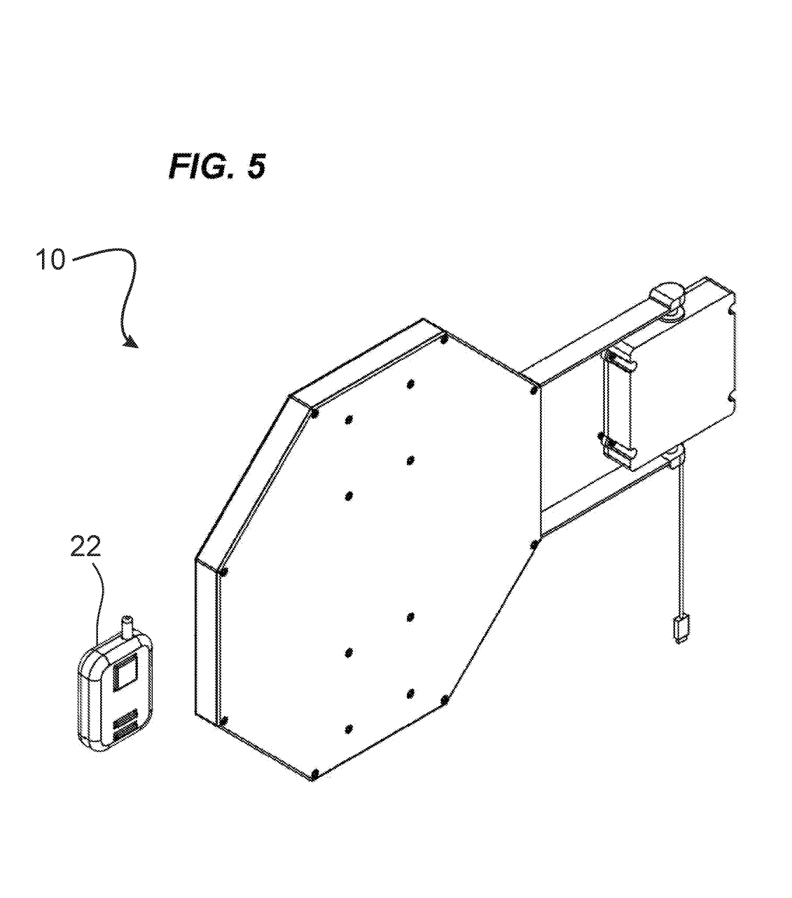

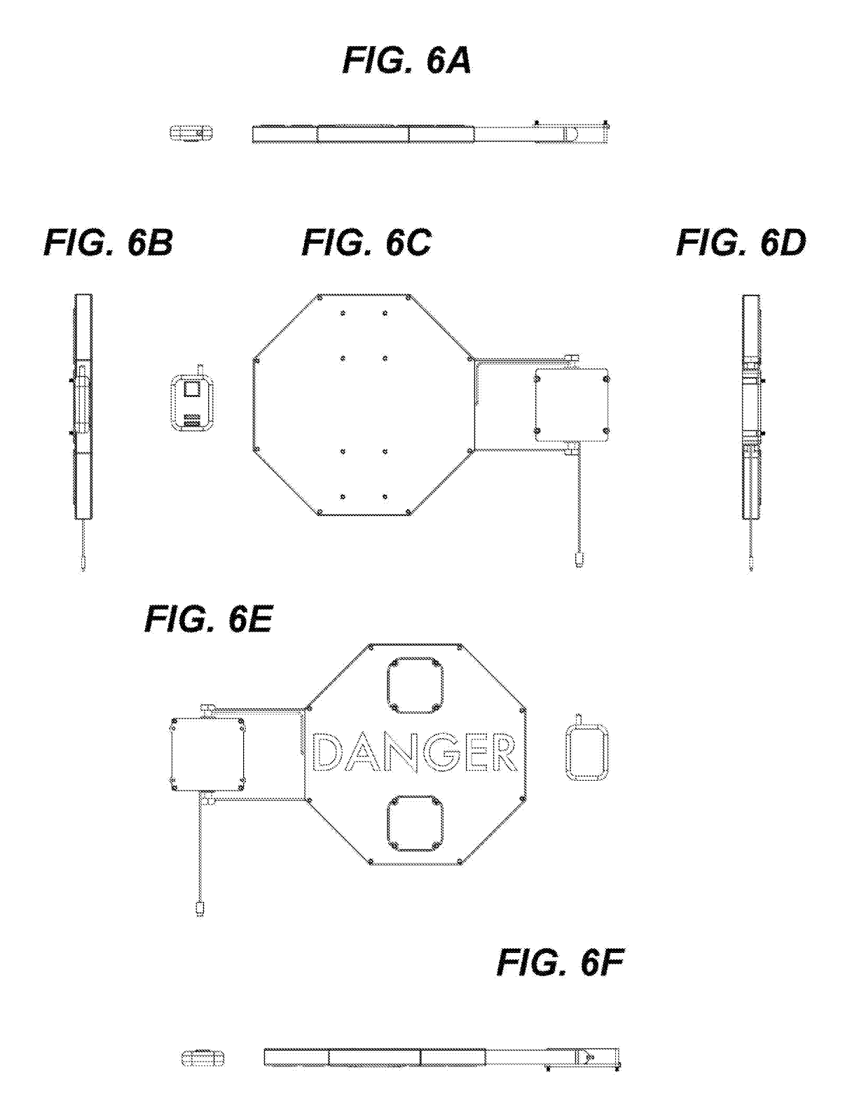

Referring now to FIGS. 3-6, various views of a safety turn panel 10 shown in a deactivated position is illustrated. In a deactivated position, arm member 14 and corresponding sign 24 is parallel with the base as illustrated as opposed to perpendicular as seen in FIG. 2. However, it should be understood, that various arrangement orientations of the base member may be provided, changing the angle between the base and the arm member when operating between an activated and deactivated position. Similarly, in a deactivated position, arm member and corresponding sign is parallel with the side of the trailer unit, and perpendicular to the side of the trailer unit when activated. In one embodiment, besides the remote control unit, other trigger mechanisms could activate the safety turn panel, such as sensors on the axle detecting backing up or the safety turn panel may be activated by the existing flasher switch. The diver, from the tractor unit, can easily control the activating (opening) and deactivating (closing) of the sign by any combination or methods disclosed herein.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

What is claimed is:

1. A safety turn panel system comprising:
a base member configured to be attached to a tractor unit of a semi-trailer truck;
an arm member rotationally attached to the base member;
a sign attached to the arm member, wherein the sign includes flashing lights in a warning text configuration and at least one reflecting panel; and
a remote control unit configured to control the sign from a deactivated to an activated position.

2. The safety turn panel system of claim 1, wherein the arm member includes a pair of arm sections.

3. The safety turn panel system of claim 1, wherein the sign is a swing out sign constructed of an octagon shape.

4. The safety turn panel system of claim 3, wherein the swing out sign is provided to warn people in a surrounding area that the semi-trailer truck is backing up and a plurality of blind spots are present.

5. A safety turn panel comprising:
a base member configured to be attached to a tractor unit of a semi-trailer truck;
an arm member rotationally attached to the base member;
a swing out sign attached to the arm member, wherein the swing out sign includes flashing lights in a warning text configuration and at least one reflecting panel; and
an actuation means for controlling the swing out sign from a closed to an open position.

6. The safety turn panel of claim 5, wherein the arm member includes a pair of arm sections.

7. The safety turn panel of claim 5, wherein the swing out sign constructed of an octagon shape.

8. The safety turn panel of claim 7, wherein the swing out sign is provided to warn people in a surrounding area that the semi-trailer truck is backing up and a plurality of blind spots are present.

9. The safety turn panel of claim 5, wherein the actuation means is a remote control unit.

10. The safety turn panel of claim 5, wherein the actuation means is an existing flasher switch in the semi-trailer truck.

11. The safety turn panel of claim 5, wherein the actuation means is a sensor on an axle of the semi-trailer truck configured to detect that the semi-trailer truck is backing up.
